(19) United States
(12) Patent Application Publication
(10) Pub. No.: US 2025/0246376 A1
(43) Pub. Date: Jul. 31, 2025

(54) METHOD FOR PRODUCING LEAD MEMBER-EQUIPPED ELECTROCHEMICAL DEVICE ELECTRODE, AND METHOD FOR PRODUCING ELECTROCHEMICAL DEVICE

(71) Applicant: Panasonic Intellectual Property Management Co., Ltd., Osaka (JP)

(72) Inventors: Kazuya MIYAFUJI, Aichi Ken (JP); Yusuke NAKAMURA, Osaka Fu (JP)

(73) Assignee: Panasonic Intellectual Property Management Co., Ltd., Osaka (JP)

(21) Appl. No.: 18/848,598

(22) PCT Filed: Mar. 22, 2023
(86) PCT No.: PCT/JP2023/011257

§ 371 Date: Sep. 19, 2024

(30) Foreign Application Priority Data
Mar. 29, 2022 (JP) 2022-053719

(51) Int. Cl. H01G 11/86; H01G 11/38; H01G 11/68

(52) U.S. Cl. CPC H01G 11/86; H01G 11/38; H01G 11/68

(57) ABSTRACT

A method for producing a lead member-equipped electrochemical device electrode includes: preparing a slurry including activated carbon and a binder, and a surface-roughened current collecting foil; applying the slurry to a surface of the current collecting foil, and drying the slurry to form an active layer, thus obtaining an electrode; and connecting the electrode and a lead member to each other. During the application of the slurry to the current collecting foil, the application is performed intermittently to form, on a portion of the electrode, a non-applied region where the surface of the current collecting foil is exposed, during the connecting of the electrode and the lead member, the lead member is attached to the non-applied region, the binder includes an elastomer, and a content of the elastomer in the active layer is greater than 0.25 mass % and less than 3 mass %.

### TECHNICAL FIELD

The present disclosure relates to a method for producing a lead member-equipped electrochemical device electrode, and a method for producing an electrochemical device.

### BACKGROUND ART

An electric double layer capacitor is known as an example of an electrochemical device. An electric double layer capacitor has a longer life than a secondary battery, is capable of quick charging, and also has excellent output characteristics. Accordingly, electrochemical devices such as an electric double layer capacitor are widely used as backup power sources and the like.

An electric double layer capacitor includes, for example, a wound body (capacitor element) formed by winding a pair of polarizable electrodes with a separator interposed therebetween, and an electrolytic solution. The electrodes are each obtained, for example, by applying a slurry including activated carbon to the surface of a surface-roughened current collecting foil (e.g., an etched foil made of aluminum), and drying the slurry, to form an active layer (e.g., Patent Literature 1).

A lead member is connected to each of the electrodes. The connection between the electrode and the lead member is performed by forming, on a portion of the electrode, a region where the surface of the current collecting foil is exposed (hereinafter also simply referred to as a “current collecting foil exposed portion”), and attaching the lead member to the current collecting foil exposed portion. Usually, the formation of the current collecting foil exposed portion is performed by hot pressing a portion of the active layer formed on the surface of the current collecting foil, and then scraping that portion off using a bush or the like. The hot pressing is performed in order to facilitate removal of the portion of the active layer using a bush or the like.

### CITATION LIST

### Patent Literature

Patent Literature 1: Japanese Patent No. 5278670

### SUMMARY OF INVENTION

### Technical Problem

When the formation of the current collecting foil exposed portion is performed by cutting away a portion of the active layer using hot pressing and a bush or the like, the active layer is likely to be detached from the current collecting foil in the vicinity of the current collecting foil exposed portion. Furthermore, in this case, the surface roughness of the current collecting foil exposed portion is increased, so that the resistance between the electrodes and the respective lead members is likely to be increased. This results in degradation in the performance of the electrochemical device.

### Solution to Problem

In view of the foregoing, an aspect of the present disclosure relates to a method for producing a lead member-equipped electrochemical device electrode, the method including: a first step of preparing a slurry including activated carbon and a binder, and a surface-roughened current collecting foil; a second step of applying the slurry to a surface of the current collecting foil, and drying the slurry to form an active layer, thus obtaining an electrode; and a third step of connecting the electrode and a lead member to each other, wherein, in the second step, the application of the slurry to the current collecting foil is performed intermittently to form, on a portion of the electrode, a non-applied region where the surface of the current collecting foil is exposed, in the third step, the lead member is attached to the non-applied region, the binder includes an elastomer, and a content of the elastomer in the active layer is greater than 0.25 mass % and less than 3 mass %.

Another aspect of the present disclosure relates to a method for producing an electrochemical device, the method including: step A of preparing a first lead member-equipped first electrode and a second lead member-equipped second electrode; step B of winding the first electrode and the second electrode with a separator interposed therebetween, to obtain a wound body; and step C of incorporating an electrolytic solution in the wound body, wherein, in the step A, at least one of the first lead member-equipped first electrode and the second lead member-equipped second electrode is obtained using the above-described method for producing a lead member-equipped electrochemical device electrode.

### Advantageous Effects of Invention

According to the present disclosure, it is possible to suppress degradation in the performance of an electrochemical device.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A front view schematically showing an exemplary lead-equipped electrode.

FIG. 2 A cross-sectional view schematically showing the exemplary lead-equipped electrode.

FIG. 3 A partially cut-away perspective view of an electrochemical device.

### DESCRIPTION OF EMBODIMENT

Hereinafter, an embodiment of the present invention will be described. However, an electrochemical device according to the present invention is not limited to the following embodiment. Although examples of specific numerical values and materials may be given in the following description, other numerical values and materials may be used as long as the effects of the present disclosure can be achieved. In the present specification, the expression “from a numerical value A to a numerical value B” includes the numerical value A and the numerical value B, and can be read as “a numerical value A or more and a numerical value B or less”.

In the following description, the term “including” is an expression encompassing “including”, “consisting essentially of”, and “consisting of”.

A method for producing a lead member-equipped electrochemical device electrode according to an embodiment of the present disclosure includes first to third steps. In the first step, a slurry including an electrode material, and a surface-roughened current collecting foil are prepared. In the second step, the slurry is applied to the surface of the current collecting foil, and the slurry is dried, to form an active layer, thus obtaining an electrode. In the third step, the electrode and a lead member are connected to each other. The electrode material includes, as essential components, activated carbon serving as an active material, and a binder. The active layer is a layer of the electrode material. The electrode including activated carbon adsorbs ions during charging, and desorbs ions during discharging.

In the second step, the application of the slurry to the current collecting foil is performed intermittently to form, on a portion of the electrode, a non-applied region where the surface of the current collecting foil is exposed. In the third step, the lead member is attached to the non-applied region.

By forming a current collecting foil exposed portion (non-applied region) by the intermittent application, it is possible to suppress detachment of the active layer from the current collecting foil in the vicinity of the current collecting foil exposed portion which happens in the case when the current collecting foil exposed portion is formed by partially cutting away the active layer using hot pressing and a brush or the like. In addition, it is possible to suppress an increase in the surface roughness of the current collecting foil exposed portion, and an increase in the resistance in a connection portion between the electrode and the lead member resulting therefrom. Consequently, degradation in the performance of the electrochemical device is suppressed.

The binder includes an elastomer, and the content of the elastomer in the active layer (electrode material) is greater than 0.25 mass % and less than 3 mass %. Note that the content of the elastomer in the active layer (electrode material) means a mass ratio (percentage) of the elastomer relative to the entire active layer (electrode material).

When the content of the elastomer in the active layer (electrode material) is greater than 0.25 mass %, the binding force of the active layer is increased to enhance the adhesion between the active layer and the current collecting foil, so that an electrochemical device with a low internal resistance can be obtained. In addition, the detachment of the active layer is suppressed, thus suppressing the occurrence of a micro-short circuit and a capacitance reduction in the electrochemical device.

However, when the content of the elastomer in the active layer (electrode material) is increased to 3 mass % or more, the viscosity of the slurry used to form the active layer will be increased to cause tailing of a coating film during the intermittent application of the slurry to the current collecting foil, and the reliability in the formation of the current collecting foil exposed portion may be reduced.

From the viewpoint of further reducing the internal resistance of the electrochemical device, the content of the elastomer in the active layer is preferably 0.5 mass % or more and 2.5 mass % or less.

As the surface-roughened current collecting foil, it is possible to use a metal foil that has been subjected to etching (etched foil). An etched foil has an advantage over a plane foil in terms of enhanced adhesion between the active layer and the current collecting foil. By using an etched foil as the current collecting foil, the adhesion between the active layer and the current collecting foil can be enhanced with a small amount (less than 3 mass % (or 2.5 mass % or less)) of an elastomer (e.g., SBR).

An active layer including activated carbon does not cause significant expansion and contraction that could be caused by an active material layer of a lithium ion secondary battery (LIB). Accordingly, an etched foil with appropriate thickness and strength can be used as the current collecting foil as long as the energy density is not impaired. Note that for the LIB, an active material (e.g., graphite, a Si-based active material, etc.) that absorbs and desorbs lithium ions is used, and the active material undergoes significant expansion and contraction during charging and discharging. Considering the expansion and contraction of the active material layer, and the thickness and the strength of the current collecting foil that are required for the LIB, it is difficult to use an etched foil for the LIB.

### (First Step)

### (Slurry)

The slurry is prepared by dispersing an electrode material in a dispersing medium. The electrode material includes at least activated carbon and a binder. For example, water can be used as the dispersing medium. The content of water in the slurry is, for example, 60 mass % or more and 80 mass % or less relative to the entire slurry.

The activated carbon (activated carbon particles) serving as the active material is not particularly limited, and any known activated carbon used for electrochemical devices may be used. The activated carbon may be produced, for example, by carbonizing a raw material through heating, and activating the resulting carbonized material. Examples of the raw material include wood, coconut shells, pulp spent liquor, coal or coal-based pitch obtained by pyrolysis thereof, heavy oil or petroleum-based pitch obtained by pyrolysis thereof, phenol resin, petroleum coke, and coal coke. Examples of the activation include gas activation using a gas such as water vapor, and chemical activation using an alkali such as potassium hydroxide. Activated carbon particles obtained by the above-described activation may be subjected to pulverization. After the pulverization, classification may be performed. For example, a ball mill, a jet mill, and the like can be used for the pulverization.

The content of the activated carbon in the electrode material (active layer) is not particularly limited, and may be 60 mass % or more and 95 mass % or less, or 70 mass % or more and 90 mass % or less. The content of the activated carbon in the electrode material (active layer) means the mass ratio (percentage) of the activated carbon relative to the entire electrode material (active layer).

The binder includes at least an elastomer. The elastomer includes, for example, a rubber component, and may include at least one selected from the group consisting of styrene-butadiene rubber (SBR), acrylic rubber, and acrylonitrile butadiene rubber. Among these, SBR is preferred in that a small amount of addition thereof can increase the binding force of the active layer and the adhesion between the active layer and the current collecting foil. The binder may be composed only of SBR.

Styrene-butadiene rubber is a copolymer produced using styrene and butadiene as main monomers (e.g., a copolymer of styrene and butadiene), and may be a modified product of a copolymer of these monomers.

Acrylic rubber is a polymer produced using an acrylic acid ester as a main monomer. Examples of the acrylic rubber include a copolymer of two or more monomers including an acrylic acid ester and another monomer, and also include a modified product of these copolymers. Examples of the other monomer include 2-chloroethyl vinyl ether and acrylonitrile. Examples of the acrylic acid ester include ethyl acrylate, butyl acrylate, and methoxy ethyl acrylate. Two or more kinds of acrylic acid esters may be used as a mixture. The acrylic rubber may be fluorinated.

The binder may include another component other than the elastomer, and may include, for example, a resin component such as polytetrafluoroethylene (PTFE). The proportion of the elastomer in the binder may be 75 mass % or more, 90 mass % or more, or 100 mass %.

The electrode material may include another component other than the activated carbon and the binder. Examples of the other component include a conductive agent and a thickener. For example, carbon black such as acetylene black can be used as the conductive agent. For example, carboxymethyl cellulose (CMC) (including, for example, an alkali metal salt and an ammonium salt of CMC) can be used as the thickener.

The slurry may have a TI value of 2 or more and 4 or less, or 2.5 or more and 4 or less. When the TI value of the slurry is 2 or more, the tailing of the coating film is likely to be suppressed, so that the reliability in the formation of the current collecting foil exposed portion is increased. When the TI value of the slurry is 4 or less, the binding force of the active layer is likely to be increased, and the adhesion between the active layer and the current collecting foil is likely to be enhanced. When the proportion of the elastomer (e.g., SBR) in the electrode material is greater than 0.25 mass % and less than 3 mass % (or 0.5 mass % or more and 2.5 mass % or less), the TI of the slurry can be easily adjusted within the above-described range.

The TI value of the slurry can be determined as follows.

The viscosity of the slurry at 25° C. is measured using a B type viscometer or an E type viscometer. A viscosity η1 of the slurry at a number of revolutions of 1 rpm, and a viscosity η2 of the slurry at a number of revolutions of 10 rpm are determined. A ratio: η1/η2 of the viscosity η1 to the viscosity η2 is calculated as the TI value.

### (Current Collecting Foil)

The arithmetic mean roughness Ra of the surface of the current collecting foil is preferably 0.5 μm or more and 1 μm or less. The arithmetic mean roughness Ra of the surface of the current collecting foil that has been subjected to etching is, for example, 0.5 μm or more, and may be 0.6 μm or more. When the arithmetic mean surface roughness Ra of the surface of the current collecting foil is 1 μm or less, the resistance in the connection portion between the electrode (current collecting foil exposed portion) and the lead member is likely to be reduced. By the above-described intermittent application, a current collector exposed portion having a surface with an arithmetic mean roughness Ra in the above-described range can be easily formed. Note that the arithmetic mean roughness Ra is an index indicating a surface roughness, and can be determined in accordance with JIS B 0601:2013.

The thickness of the current collecting foil may be 30 μm or less, or 20 μm or less. By reducing the thickness of the current collecting foil to 20 μm or less, it is possible to increase the filling amount of the active material, thus achieving a higher capacitance. When an elastomer (e.g., SBR) is used as the binder for a thin current collecting foil having a thickness of 20 μm or less, the binding force of the active layer and the adhesion between the active layer and the current collecting foil are large, and the strength of the current collecting foil is low. Therefore, it is difficult to remove a portion of the active layer using a brush or the like. Accordingly, in the above-described case, it is effective to form the current collecting foil exposed portion by the intermittent application of the slurry to the current collecting foil.

The materials of the current collecting foil include aluminum, an aluminum alloy, nickel, and titanium. Among these, aluminum or an aluminum alloy are preferred because of the low cost, the moderate strength, and the high conductivity.

### (Second Step)

In the second step, the slurry is applied to the surface of the current collecting foil, and the resulting coating film is dried, and optionally compressed, to form an active layer. The dispersing medium contained in the slurry is removed by drying, whereby an electrode material layer serving as an active layer is formed. The thickness (thickness per one surface) of the active layer is, for example, 40 μm or more and 80 μm or less. The slurry may be applied to one surface of the current collecting foil, or may be applied to both surfaces of the current collecting foil. The application of the slurry to the current collecting foil is performed intermittently, to form an applied region and a non-applied region. When the slurry is applied to both surfaces of the current collecting foil, an applied region and a non-applied region may be formed in the same pattern on both surfaces of the current collecting foil.

The application method is not particularly limited as long as the method allows intermittent application, and examples thereof include die coating, comma coating, and gravure coating. Among these, die coating is preferred as the application method in that there is no entry of foreign matter because of the sealed state, and that the use of a pump allows the application amount of the slurry to be easily controlled.

Along current collecting foil may be supplied in an application device, and the slurry may be applied intermittently to both surfaces of the current collecting foil, to form a predetermined applied pattern, thus forming an active layer, which may then be cut at a predetermined position, to produce a plurality of electrodes each having a current collecting foil exposed portion on a portion thereof.

### (Third Step)

In the third step, the electrode and the lead member are connected to each other by attaching the lead member to the non-applied region of the electrode. The attachment of the lead member to the non-applied region of the electrode can be performed, for example, by crimping using a needle-shaped member, or cold welding or the like.

The lead member includes, for example, a flat tab part, a lead wire, and a connection part that connects the tab part and the lead wire to each other. The lead member is not particularly limited as long as it is a conductive member including a tab part, a connection part, and a lead wire, and the lead member can be prepared, for example, as follows. A rod-shaped metal member is prepared, and one end of the member is flattened by pressing or the like, to form a tab part. The other end is left as being rod-shaped, to serve as a connection part. The connection part and the lead wire are connected to each other by welding or the like.

The connection between the electrode and the lead member by crimping can be performed, for example, as follows. The tab part of the lead member is disposed on one surface of the non-applied region of the electrode, to form an overlapping portion between the tab part and the non-applied region. The overlapping portion is perforated at a predetermined position from the tab part side using a needle-shaped member, to form a through hole. Along with the formation of the through hole, a portion of the tab part is caused to protrude from the other surface of the non-applied region of the electrode, to form a protrusion. Thereafter, the overlapping portion is pressed, and the protrusion is bent on the other surface of the non-applied region so as to be in close contact therewith, to form a petal-shaped crimp piece. The crimping is performed, for example, separately on two to four predetermined positions within the non-applied region.

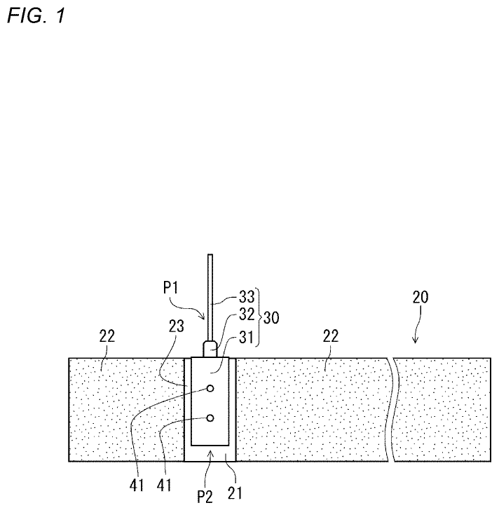

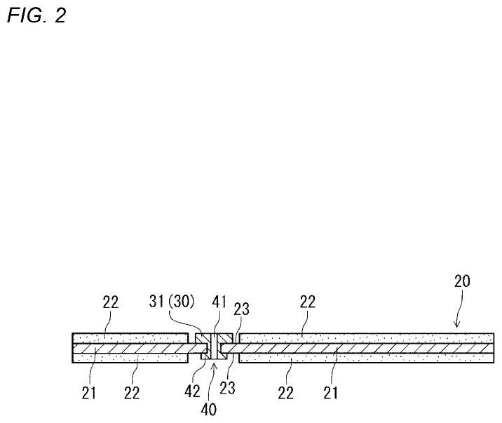

Here, FIG. 1 is a front view schematically showing an exemplary lead member-equipped electrode obtained by a method for producing a lead member-equipped electrode according to the present embodiment. FIG. 2 is across-sectional view schematically showing the exemplary lead member-equipped electrode obtained by the method for producing a lead member-equipped electrode according to the present embodiment. FIG. 2 shows a cross section including a crimp part 40. The members in the drawings are schematically shown, and the relationship between the sizes and the thicknesses of the members is not limited to that shown in the drawings.

A band-shaped electrode 20 includes a surface-roughened current collecting foil 21, and active layers 22 supported on both surfaces of the current collecting foil 21. The electrode 20 has, on a portion thereof, a current collecting foil exposed portion 23. Current collecting foil exposed portions 23 are respectively formed on both surfaces of the electrode 20, and the current collecting foil exposed portions 23 on both surfaces of the electrode 20 are formed so as to substantially coincide with each other when the electrode 20 is viewed from the direction of the normal of a principal surface thereof. Meanwhile, a lead member 30 includes a flat tab part 31, a connection part 32, and a lead wire 33. The lead member 30 is attached by crimping the tab part 31, with the tab part 31 disposed on the current collecting foil exposed portion 23 on one surface of the electrode 20. In this manner, the electrode 20 and the lead member 30 are connected to each other. A crimp part 40 formed by crimping has a through hole 41, and includes a crimp piece 42 formed on the current collecting foil exposed portion 23 on the other surface of the electrode 20. Although two crimp parts 40 are provided, the number of crimp parts 40 is not limited thereto. In the present embodiment, the current collecting foil exposed portions 23 are each obtained by intermittent application (formation of the non-applied region).

### [Method for Producing Electrochemical Device]

A method for producing an electrochemical device according to an embodiment of the present disclosure includes: step A of preparing a first lead member-equipped first electrode and a second lead member-equipped second electrode; step B of winding the first electrode and the second electrode with a separator interposed therebetween, to obtain a wound body; and step C of incorporating an electrolytic solution in the wound body. In the step A, at least one of the first lead member-equipped first electrode and the second lead member-equipped second electrode is obtained by the method for producing a lead member-equipped electrochemical device electrode according to the embodiment of the present disclosure. Hereinafter, a lead member-equipped electrode obtained by the method for producing a lead member-equipped electrochemical device electrode according to the embodiment of the present disclosure will be also referred to as a “lead member-equipped electrode E”.

Examples of the electrochemical device include an electric double layer capacitor (EDLC) and a lithium ion capacitor (LIC). When the electrochemical device is an EDLC, the lead member-equipped electrode E may be used as at least one of a pair of lead member-equipped electrodes. When the electrochemical device is a LIC, the lead member-equipped electrode E may be used as one (positive electrode) of a pair of lead member-equipped electrodes, and a lead member-equipped negative electrode used for a lithium ion secondary battery may be used as the other (negative electrode) of the pair of lead member-equipped electrodes. The negative electrode used for a lithium ion secondary battery includes, for example, a negative electrode active material (e.g., graphite) capable of absorbing and desorbing lithium ions.

The electrolytic solution includes a solvent (non-aqueous solvent) and an ionic substance. The ionic substance is dissolved in the solvent, and includes a cation and an anion. The ionic substance may include, for example, a low-melting point compound (ionic liquid) that can exist as a liquid around room temperature. The concentration of the ionic substance in the electrolytic solution is, for example, 0.5 mol/L or more and 2.0 mol/L or less.

As the solvent, a high-boiling point solvent is preferred. For example, it is possible to use lactones such as γ-butyrolactone, carbonates such as propylene carbonate, polyhydric alcohols such as ethylene glycol and propylene glycol, cyclic sulfones such as sulfolane, amides such as N-methylacetamide, N,N-dimethylformamide, and N-methyl-2-pyrrolidone, esters such as methyl acetate, ethers such as 1,4-dioxane, ketones such as methyl ethyl ketone, and formaldehyde.

The ionic substance includes, for example, an organic salt. An organic salt is a salt in which at least one of the anion and the cation contains an organic material. Examples of the organic salt in which the cation contains an organic material include a quaternary ammonium salt. Examples of the organic salt in which the anion (or both ions) contains an organic material include trimethylamine maleate, triethylamine borodisalicylate, ethyldimethylamine phthalate, mono 1,2,3,4-tetramethylimidazolinium phthalate, and mono 1,3-dimethyl-2-ethylimidazolinium phthalate.

From the viewpoint of enhancing the voltage endurance properties, the anion preferably includes an anion of a fluorine-containing acid. Examples of an anion of a fluorine-containing acid include BF₄⁻ and/or PF₆⁻. Preferably, the organic salt includes, for example, a cation of tetraalkylammonium and an anion of a fluorine-containing acid. Specific examples thereof include diethyl dimethyl ammonium tetrafluoroborate (DEDMABF₄) and triethyl methyl ammonium tetrafluoroborate (TEMABF₄).

Preferably, a separator is interposed between the pair of electrodes. The separator has ion permeability, and serves to physically separate the pair of electrodes from each other to prevent a short circuit. For example, a non-woven fabric composed mainly of cellulose, a glass fiber mat, or a microporous film of polyolefin such as polyethylene can be used as the separator.

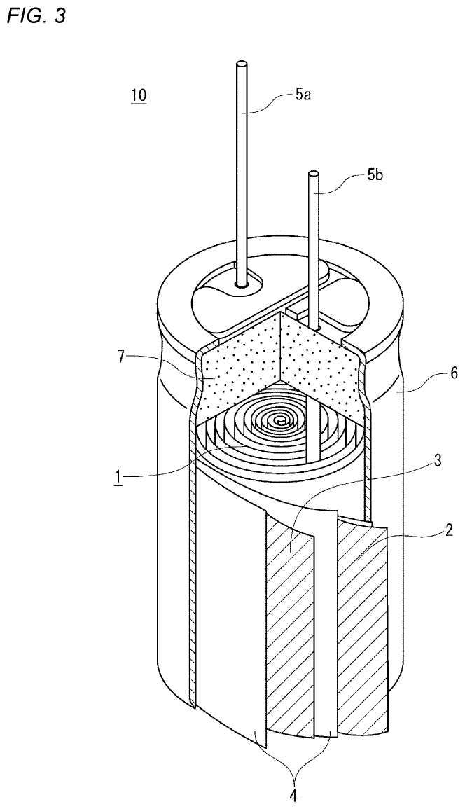

Here, FIG. 3 is a partially cut-away perspective view of an electrochemical device obtained by the method for producing an electrochemical device according to the embodiment of the present disclosure. Note that FIG. 3 shows an exemplary electrochemical device obtained by the method for producing an electrochemical device according to the embodiment of the present disclosure.

An electrochemical device 10 shown in FIG. 3 is an electric double layer capacitor, and includes a wound capacitor element 1. The capacitor element 1 is formed by winding a first electrode 2 and a second electrode 3 each having a sheet shape, with a separator 4 interposed therebetween. The first electrode 2 and the second electrode 3 respectively include a first current collector and a second current collector each made of metal, and a first active layer and a second active layer respectively supported on surfaces of the first current collector and the second current collector, and exhibits a capacitance by absorbing and desorbing ions.

For example, an aluminum foil that has been subjected to etching can be used as the current collecting foil. For example, a non-woven fabric composed mainly of cellulose can be used as the separator 4. A first lead member 5a and a second lead member 5b are connected to the first electrode 2 and the second electrode 3, respectively. The capacitor element 1 is accommodated in a cylindrical exterior case 6, together with an electrolytic solution (not shown). The material of the exterior case 6 may be, for example, a metal such as aluminum, stainless steel, copper, iron, and brass. An opening of the exterior case 6 is sealed by a sealing member 7. The lead wires 5a and 5b are led out to the outside so as to penetrate the sealing member 7. For example, a rubber material such as butyl rubber can be used for the sealing member 7.

Hereinafter, the present disclosure will be described in detail by way of examples. However, the present disclosure is not limited to the examples.

### Example 1

As an electrochemical device, a wound electric double layer capacitor with a rated voltage of 2.7 V was produced. In the following, a specific method for producing the electrochemical device will be described.

### (Production of Electrode)

Water was added to the electrode material, to prepare a slurry. A mixture of 88.25 parts by mass of activated carbon particles, 1.75 parts by mass of styrene-butadiene rubber (SBR) serving as a binder, 4 parts by mass of carboxymethyl cellulose (CMC) serving as a thickener, and 6 parts by mass of acetylene black (AB) serving as a conductive agent was used as the electrode material. The content of SBR in the electrode material was 1.75 mass % relative to the entire electrode material. The content of water in the slurry was 75 mass % relative to the entire slurry. The TI value of the slurry obtained by the previously described method was 2.5.

The obtained slurry was applied to both surfaces of a band-shaped current collecting foil, and the resulting coating film was vacuum-dried at 110° C., and rolled to form an active layer (thickness per surface: 40 μm), thus obtaining an electrode (length: 500 mm, width: 59 mm). An Al-etched foil (thickness: 20 μm, arithmetic mean roughness Ra: 0.89 μm) was used as the current collecting foil.

The above-described application of the slurry to the current collecting foil was performed intermittently, to form applied regions and non-applied regions in the same pattern on both surfaces of the current collecting foil. A slot die was used as the application device. In this manner, an electrode a1 including a current collecting foil and active layers formed on both surfaces of the current collecting foil, and having, on a portion thereof, a current collecting foil exposed portion (dimension of the electrode in the length direction: 6 mm) formed by the non-applied region was obtained.

(Connection between Electrode and Lead Member)

A lead member including a lead wire, a connection part, and a tab part was prepared. With the tab part of the lead member disposed on one surface of the current collecting foil exposed portion of the electrode, crimping was performed on an overlapping portion between the current collecting foil exposed portion and the tab part. In this manner, the tab part was attached to the current collecting foil exposed portion, to obtain a lead member-equipped electrode a1.

### (Preparation of Electrolytic Solution)

Diethyl dimethyl ammonium tetrafluoroborate (DEDMABF₄) was dissolved in γ-butyrolactone (GBL), to prepare an electrolytic solution. The concentration of DEDMABF₄ in the electrolytic solution was 1.0 mol/L.

### (Production of Electrochemical Device)

Two lead member-equipped electrodes obtained as described above were prepared, and wound with a separator made of a cellulose non-woven fabric interposed therebetween, to form a capacitor element, which was then accommodated in a predetermined exterior case together with the electrolytic solution, and sealed by a sealing member, thus completing an electrochemical device A1. Thereafter, the electrochemical device A1 was subjected to aging at 60° C. for 16 hours, under application of a rated voltage.

The lead member-equipped electrode a1 and the electrochemical device A1 obtained as described above were evaluated as follows.

### [Evaluation]

### (Peel Strength of Active Layer)

The electrode was cut into 15 mm width, to obtain a sample. The sample was fixed on a predetermined stand via 20-mm-wide double-sided tape (NW-20 manufactured by Nichiban Co., Ltd.) 12-mm-wide masking tape (No. 7239 manufactured by Nitto Denko Corporation) was attach onto the sample. One end portion of the masking tape in the length direction was pulled using a force gage, and the force (peel strength) required to tear off the active layer was measured. At this time, the average value of the peel strengths measured in 15 seconds during which the peel strength has been stabilized was determined.

(Crimping Resistance between Electrode and Lead Member)

The resistance (crimping resistance) between the portion indicated by the arrow P1 in FIG. 1 and the portion indicated by the arrow P2 in FIG. 1 was measured using a digital multimeter. The portion indicated by the arrow P1 in FIG. 1 is an end portion of the lead wire 33 on the tab part 31 side. The portion indicated by the arrow P2 in FIG. 1 is the vicinity of an end portion of the tab part 31 on the side opposite to the lead wire 33 on the current collecting foil exposed portion 23.

### (Capacitance of Electrochemical Device)

Under an environment at −30° C., constant-current charging was performed at a current of 1.35 A until the voltage reached 2.35 V, and thereafter a state in which a voltage of 2.35 V was applied was maintained for 10 minutes. Thereafter, under an environment at −30° C., constant-current discharging was performed at a current of 1 A until the voltage reached 0 V.

In the above-described discharging, a time t (sec) required for the voltage to drop from 2.0 V to 1.6 V was measured. Using the measured time t, a capacitance C1 (F) of the electrochemical device was determined by the following expression (1):

$$Capacitance C 1 = Id \times t / V \qquad ( 1 )$$

Note that in the expression (1), Id is the current value (1.0 A) during discharging, and V is the value (0.4 V) obtained by subtracting 1.6 V from 2.0 V.

### (Direct-Current Resistance (DCR) of Electrochemical Device)

Under an environment at −30° C., constant-current charging was performed at a current of 1.35 A until the voltage reached 2.35 V, and thereafter a state in which a voltage of 2.35 V was applied was maintained for 10 minutes. Thereafter, under an environment at −30° C., constant-current discharging was performed at a current of 1.35 A until the voltage reached 0 V.

Using a discharge curved line (vertical axis: discharge voltage, horizontal axis: discharging time) obtained by the above-described discharging, a primary approximate line of the discharge curved line in the range from 0.5 to 2 seconds after the start of discharging, and a voltage VS of an intercept of the approximate line was determined. The value (V0-VS) obtained by subtracting the voltage VS from a voltage V0 at the start of discharging (0 seconds after the start of discharging) was obtained as ΔV. Using the ΔV (V) and a current value Id (1.35 A) during discharging, an internal resistance (DCR) R1 (Ω) of the electrochemical device was determined by the following expression (2):

$$Internal resistance R 1 = Δ V / Id \qquad ( 2 )$$

### (Remaining Capacitance of Electrochemical Device)

Under an environment at 25° C., constant-current charging was performed at a current of 1.35 A until the voltage reached 2.5 V, and then constant-voltage charging at 2.5 V was performed for 5 hours. Thereafter, under an environment at 60° C., the electrochemical device was allowed to stand for 24 hours. After standing for 24 hours, the voltage of the electrochemical device was measured under an environment at 25° C. When the voltage of the electrochemical device after standing for 24 hours was 2.3 V or more, it was determined that a micro-short circuit was suppressed, and the remaining capacitance was high.

### Comparative Example 1

A lead member-equipped electrode b1 was produced in the same manner as in Example 1 except that polytetrafluoroethylene (PTFE) was used as the binder in place of SBR, then an electrochemical device B1 was produced, and they were evaluated.

### Comparative Example 2

Polytetrafluoroethylene (PTFE) was used as the binder in place of SBR.

In the step of applying the slurry to the current collecting foil, the slurry was applied all over both surfaces of the current collecting foil, to form an active layer. Thereafter, a portion of the active layer was hot-pressed for 3 seconds at a temperature of 250 to 280° C., and subsequently the portion was removed using a brush. In this manner, a current collecting foil exposed portion was formed on a predetermined portion of the electrode.

Except for the foregoing, a lead member-equipped electrode b2 was produced in the same manner as in Example 1, then an electrochemical device B2 was produced, and they were evaluated.

### Comparative Example 3

In the step of applying the slurry to the current collecting foil, the slurry was applied all over both surfaces of the current collecting foil, to form an active layer. Thereafter, a portion of the active layer was hot-pressed, and subsequently an attempt was made to remove the portion using a brush was made. However, due to the small thickness of the current collecting foil, as well as the strong binding force of the active layer, and the high adhesion between the active layer and the current collecting foil, the active layer was difficult to remove, thus making it impossible to form a current collecting foil exposed portion.

### Comparative Example 4

The Al-etched foil used as the current collecting foil had a thickness of 30 μm. In the step of applying the slurry to the current collecting foil, the slurry was applied all over both surfaces of the current collecting foil, to form an active layer. Thereafter, a portion of the active layer was hot-pressed, and subsequently the portion was removed using a brush. In this manner, a current collecting foil exposed portion was formed on a predetermined portion of the electrode.

Except for the foregoing, a lead member-equipped electrode b4 was produced in the same manner as in Example 1, then an electrochemical device B4 was produced, and they were evaluated.

The results of the evaluation are shown in Table 1. Note that Tables 1 and 2 show the TI values of the slurry that have been determined by the previously described method. The symbol ∘ in the column of Tailing of coating film in Tables 1 and 2 indicates that no tailing of the coating film was visually confirmed during the intermittent application of the slurry to the current collecting foil. On the other hand, the symbol x in the column of Tailing of coating film indicates that tailing of the coating film was visually confirmed during the intermittent application of the slurry to the current collecting foil. The symbol ∘ in the column of Remaining capacitance in Tables 1 and 2 indicates that the voltage of the electrochemical device after standing for 24 hours was 2.3 V or more, and a high remaining capacitance was obtained. On the other hand, the symbol x in the column of Remaining capacitance indicates that the voltage of the electrochemical device after standing for 24 hours was less than 2.3 V, and a low remaining capacitance was obtained.

TABLE 1

| | | | | | Arithmetic | | | |
|---|---|---|---|---|---|---|---|---|
| | | | | | mean | | | |
| | | | | | roughness | | | |
| | | | | | Ra of | | | |
| | | | | Formation | surface of | Binder | | |
| | | | | method of | current | | Content | |
| | | | Thickness | current | collecting | | in | |
| | | Lead | of current | collecting | foil | | electrode | |
| | Electro- | member- | collecting | foil | exposed | | material | |
| | chemical | equipped | foil | exposed | portion | | (parts by | TI value |
| | device | electrode | (μm) | portion | (μm) | Type | mass) | of slurry |
| Example | A1 | a1 | 20 | Intermittent | 0.89 | SBR | 1.75 | 2.5 |
| 1 | | | | application | | | | |
| Com. | B1 | b1 | 20 | Intermittent | 0.89 | PTFE | 1.75 | 2.5 |
| Ex. 1 | | | | application | | | | |
| Com. | B2 | b2 | 20 | Removal | 1.69 | PTFE | 1.75 | 2.5 |
| Ex. 2 | | | | of active | | | | |
| | | | | layer | | | | |
| Com. | — | — | 20 | Unable to | 1.69 | SBR | 1.75 | 2.5 |
| Ex. 3 | | | | remove | | | | |
| | | | | active layer | | | | |
| Com. | B4 | b4 | 30 | Removal | 1.69 | SBR | 1.75 | 2.5 |
| Ex. 4 | | | | of active | | | | |
| | | | | layer | | | | |
| | | | | Peel | | | | |
| | | | Tailing | strength | | | | |
| | | | of | of active | Crimping | | | |
| | | | coating | layer | resistance | Remaining | DCR | Capacitance |
| | | | film | (N) | (mΩ) | capacitance | (mΩ) | (F) |
| | | Example | ○ | 1.90 | 1.49 | ○ | 20.5 | 111.3 |
| | | 1 | | | | | | |
| | | Com. | ○ | 1.43 | 1.55 | x | 20.2 | 111.4 |
| | | Ex. 1 | | | | | | |
| | | Com. | — | 1.43 | 1.72 | x | 21.4 | 110.9 |
| | | Ex. 2 | | | | | | |
| | | Com. | — | 1.90 | — | — | — | — |
| | | Ex. 3 | | | | | | |
| | | Com. | — | 1.90 | 1.74 | ○ | 18.2 | 90.1 |
| | | Ex. 4 | | | | | | |

In Example 1, SBR was used as the binder. Accordingly, for the electrode a1, the binding force of the active layer was increased, and a high peel strength was obtained. In addition, the current collecting foil exposed portion was formed by the intermittent application. Accordingly, the crimping resistance between the electrode a1 and the lead member was reduced. For the electrochemical device A1, a high capacitance and a low DCR were obtained, and a high remaining capacitance was also obtained

In Comparative Examples 1 and 2, PTFE was used as the binder. Accordingly, for the electrodes b1 and b2, the binding force of the active layer was reduced, and the peel strength was reduced. For the electrochemical devices B1 and B2, a micro-short circuit occurred, and the remaining capacitance was reduced.

Furthermore, in Comparative Example 2, the current collecting foil exposed portion was formed by removing a portion of the active layer using a brush. Accordingly, the surface roughness of the current collecting foil exposed portion was increased, and the crimping resistance between the electrode b2 and the lead member was increased. For the electrochemical device B2, the DCR was higher than that of the electrochemical device B1.

In Comparative Example 4, the current collecting foil exposed portion was formed by removing a portion of the active layer using a brush. Accordingly, the crimping resistance between the electrode b4 and the lead member was increased. In Comparative Example 4, the filling amount of the active layer was reduced as a result of increasing the thickness of the Al-etched foil serving as the current collecting foil to 30 μm, and the capacitance of the electrochemical device B4 was reduced.

### Examples 2 and 3, and Comparative Examples 5 to 7

Water was added to the electrode material, to prepare a slurry. As the electrode material, a mixture of 88.25 parts by mass of activated carbon particles, and 11.75 parts by mass of SBR, CMC, and AB in total was used. The values of the content of SBR in the electrode material relative to the entire electrode material were as shown in Table 2. The mass ratio of SBR, CMC, and AB was 1.75:4:6.

In Examples 2 and 3, and Comparative Examples 6 and 7, lead member-equipped electrodes a2 and a3, and b6 and b7 were produced in the same manner as in Example 1 except that the above-described slurries were used in the step of producing the electrode, then electrochemical devices A2 and A3, and B6 and B7 were produced, and they were evaluated.

In Comparative Example 5, the content of SBR in the electrode material was 0.25 mass %. Accordingly, although the active layer was formed in the same manner as in Example 1, the adhesion between the active layer and the current collecting foil was low, making it impossible to produce the electrode, and to measure the peel strength of the active layer.

The results of the evaluation are shown in Table 2. Table 2 also shows the results of the evaluation of Example 1.

TABLE 2

| | | | | | Arithmetic | | | |
|---|---|---|---|---|---|---|---|---|
| | | | | | mean | | | |
| | | | | | roughness | | | |
| | | | | | Ra of | | | |
| | | | | Formation | surface of | Binder | | |
| | | | | method of | current | | Content | |
| | | | Thickness | current | collecting | | in | |
| | | Lead | of current | collecting | foil | | electrode | |
| | Electro- | member- | collecting | foil | exposed | | material | |
| | chemical | equipped | foil | exposed | portion | | (parts by | TI value |
| | device | electrode | (μm) | portion | (μm) | Type | mass) | of slurry |
| Com. | — | — | 20 | Intermittent | 0.89 | SBR | 0.25 | 4.2 |
| Ex. 5 | | | | application | | | | |
| Example | A2 | a2 | 20 | Intermittent | 0.89 | SBR | 0.5 | 3.1 |
| 2 | | | | application | | | | |
| Example | A1 | a1 | 20 | Intermittent | 0.89 | SBR | 1.75 | 2.5 |
| 1 | | | | application | | | | |
| Example | A3 | a3 | 20 | Intermittent | 0.89 | SBR | 2.5 | 2.2 |
| 3 | | | | application | | | | |
| Com. | B6 | b6 | 20 | Intermittent | 0.89 | SBR | 3 | 1.5 |
| Ex. 6 | | | | application | | | | |
| Com. | B7 | b7 | 20 | Intermittent | 0.89 | SBR | 3.5 | 1.3 |
| Ex. 7 | | | | application | | | | |
| | | | | Peel | | | | |
| | | | Tailing | strength | | | | |
| | | | of | of active | Crimping | | | |
| | | | coating | layer | resistance | Remaining | DCR | Capacitance |
| | | | film | (N) | (mΩ) | capacitance | (mΩ) | (F) |
| | | Com. | ○ | Unable | — | — | — | — |
| | | Ex. 5 | | to | | | | |
| | | | | measure | | | | |
| | | Example | ○ | 1.71 | 1.51 | ○ | 20.1 | 111.8 |
| | | 2 | | | | | | |
| | | Example | ○ | 1.90 | 1.49 | ○ | 20.5 | 111.3 |
| | | 1 | | | | | | |
| | | Example | ○ | 2.10 | 1.52 | ○ | 20.3 | 110.8 |
| | | 3 | | | | | | |
| | | Com. | x | 2.34 | 1.53 | ○ | 23.4 | 109.8 |
| | | Ex. 6 | | | | | | |
| | | Com. | x | 2.59 | 1.53 | ○ | 28.9 | 111.3 |
| | | Ex. 7 | | | | | | |

In Examples 1 to 3, in which the content of SBR in the active layer (electrode material) was 0.5 mass % or more and 2.5 mass % or less, no tailing occurred during the intermittent application, and the current collecting foil exposed portion was stably formed. For the electrodes a2 and a3, as in the case of the electrode a1, the binding force of the active layer was increased by SBR, and a high peel strength was obtained. In addition, the current collecting foil exposed portion was formed by the intermittent application, so that the crimping resistance between the electrodes a2 and a3 and the respective lead members was reduced. For the electrochemical devices A2 and A3, as in the case of the electrochemical device A1, a high capacitance and a low DCR were obtained, and a high remaining capacitance was also obtained.

In Comparative Examples 6 and 7, in which the content of SBR in the active layer (electrode material) was 3 mass % or more, the viscosity of the slurry was increased, and tailing of the coating film occurred during the intermittent application, and the current collecting foil exposed portion was not stably formed. For the electrochemical devices B6 and B7, the DCR was increased.

### INDUSTRIAL APPLICABILITY

A lead member-equipped electrode obtained by a method for producing a lead member-equipped electrochemical device electrode according to the present disclosure can be suitably used for an electrochemical device that requires a low internal resistance. Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: capacitor element, 2: first electrode, 3: second electrode, 4: separator, 5a: first lead member, 5b: second lead member, 6: exterior case, 7: sealing member, 10: electrochemical device, 20: electrode, 21: current collecting foil, 22: active layer, 23: current collecting foil exposed portion, 30: lead member, 31: tab part, 32: connection part, 33: lead wire, 40: crimp part, 41: through hole, 42: crimp piece

1. A method for producing a lead member-equipped electrochemical device electrode, the method comprising:
preparing a slurry including activated carbon and a binder, and a surface-roughened current collecting foil;
applying the slurry to a surface of the current collecting foil, and drying the slurry to form an active layer, thus obtaining an electrode; and
connecting the electrode and a lead member to each other, wherein,
during the application of the slurry to the current collecting foil, the application is performed intermittently to form, on a portion of the electrode, a non-applied region where the surface of the current collecting foil is exposed,
during the connecting of the electrode and the lead member, the lead member is attached to the non-applied region,
the binder includes an elastomer, and
a content of the elastomer in the active layer is greater than 0.25 mass % and less than 3 mass %.

2. The method for producing the lead member-equipped electrochemical device electrode according to claim 1, wherein the elastomer includes styrene-butadiene rubber.

3. The method for producing the lead member-equipped electrochemical device electrode according to claim 2, wherein a content of the styrene-butadiene rubber in the active layer is 0.5 mass % or more and 2.5 mass % or less.

4. The method for producing the lead member-equipped electrochemical device electrode according to claim 2, wherein the slurry has a TI value of 2 or more and 4 or less.

5. The method for producing the lead member-equipped electrochemical device according to claim 1, wherein a surface of the non-applied region has an arithmetic mean roughness Ra of 0.5 μm or more and 1.0 μm or less.

6. The method for producing the lead member-equipped electrochemical device electrode according to claim 1, wherein the current collecting foil is an aluminum foil.

7. The method for producing the lead member-equipped electrochemical device electrode according to claim 1, wherein the current collecting foil has a thickness of 20 μm or less.

8. A method for producing an electrochemical device, the method comprising:
preparing a first lead member-equipped first electrode and a second lead member-equipped second electrode;
winding the first electrode and the second electrode with a separator interposed therebetween, to obtain a wound body; and
incorporating an electrolytic solution in the wound body, wherein,
at least one of the first lead member-equipped first electrode and the second lead member-equipped second electrode is obtained using the method for producing the lead member-equipped electrochemical device electrode according to claim 1.
